(19) United States
(12) Patent Application Publication
(10) Pub. No.: US 2004/0254091 A1
(43) Pub. Date: Dec. 16, 2004

(54) Use of quaternized dialkylaminoalkyl (meth) acrylates as soil release polymers for hard surfaces, and a method for production thereof

(76) Inventors: Gerhard Crass, Friedberg (DE); Bela Ivan, Budapest (HU); Gabor Erdodi, Csokako (HU); Arpad Mathe, Budapest (HU)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/481,294

(22) PCT Filed: Jun. 11, 2002
(86) PCT No.: PCT/EP02/06362

(30) Foreign Application Priority Data
Jun. 28, 1991 (DE) 10131371.3

(51) Int. Cl. B32B 9/04

(52) U.S. Cl. 510/528; 428/543

(57) ABSTRACT

The invention relates to the use of polymers of the formula (1)

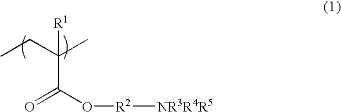

in which

R¹ is hydrogen or methyl,

R² is C₁- to C₄-alkylene,

R³, R⁴ and R⁵, independently of one another, are C₁- to C₄-alkyl groups, as soil release polymer for hard surfaces such as stoneware or metals.

The present invention relates to the use of polymers which consist essentially of units of quaternized dialkylaminoalkyl (meth)acrylates as soil release polymer for hard surfaces such as stoneware or metals. The invention further relates to a method for the production of such polymers by polymerization with specific temperature profile.

Polymers of quaternized dialkylaminoalkyl (meth)acrylates are known in principle. Soil release polymers are also known in principle. Soil release polyesters are often used for the finishing of textiles or in laundry detergents.

The object of DE-A-32 44 274 was to provide a method for the production of concentrated aqueous solutions of quaternization products of tertiary aminoalkyl esters or tertiary aminoalkylamides of acrylic or methacrylic acid by reaction of the corresponding esters or amides with an alkylating agent in a water-soluble ketone as solvent, in which easy-to-handle aqueous solutions of the quaternization products are produced which comprise no other monomers and which can be used directly in the polymerization.

This object was achieved by isolating the quaternization products by adding enough water to the reaction mixture for two phases to form and separating off the lower aqueous phase, which comprises the quaternization products in dissolved form, from the upper phase which comprises ketone and residual alkylating agent. In this method, enough water is added to the reaction mixture for the aqueous solutions of the quaternization products to be 50 to 95% strength by weight. The concentrated aqueous solutions of the basic monomers obtained in this way can be used directly without an additional purification step in polymerizations for the production of homo-polymers or copolymers.

DE-A-199 21 894, DE-A-199 21 903 and DE-A-199 21 904 disclose biocidally finished polymer substrates, to which ammonium-functional (meth)acrylic ester polymers are applied.

It has, however, been found that the soil release polyesters of the prior art are not suitable for use on hard surfaces since their adhesion to such surfaces is too poor. For the soil-repellent finishing of such surfaces, attachment of the soil release polymer to the surface is essential.

The object of the present invention was thus to find polymers which attach to hard surfaces, for example those made of stoneware or metal, sufficiently for them to be suitable as soil-repellent soil release polymer.

A further object of the invention was to provide an economic production method for such polymers. In this connection, the object was to find a production method which produces higher yields than the methods known from the prior art.

Surprisingly, it has been found that certain polymers of dialkylaminoalkyl (meth)acrylates which contain quaternized amino groups achieve this object, and can be produced by a suitable method in virtually quantitative yield.

The invention thus provides the use of polymers containing structural units of the formula 1

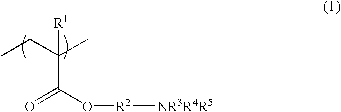

in which

R¹ is hydrogen or methyl,

R² is C₁- to C₄-alkylene,

R³, R⁴ and R⁵, independently of one another, are C₁- to C₄-alkyl groups,

as soil release polymers for hard surfaces.

The use according to the invention is preferably on mineral surfaces, such as, for example, stoneware, or on metals.

The invention further provides a method for the production of polymers containing structural units of the formula 1

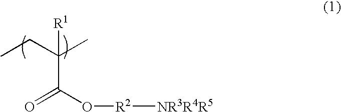

in which

R¹ is hydrogen or methyl,

R² is C₁- to C₄-alkylene,

R³, R⁴ and R⁵, independently of one another, are C₁- to C₄-alkyl groups,

by subjecting compounds of the formula 2

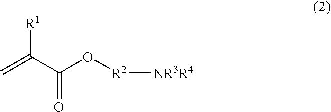

to polymerization, and reacting the resulting product with a suitable alkylating agent, which inserts the radical R⁵ such that the polymers of the formula 1 arise, wherein the reaction temperature is initially at at least 40° C. and is increased during the reaction at least once by at least 10° C.

The invention further provides a method for the production of polymers containing structural units of the formula 3

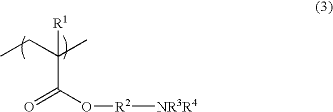

in which

R¹ is hydrogen or methyl,

R² is C₁- to C₄-alkylene,

R³, R⁴, independently of one another, are C₁- to C₄-alkyl groups,

by subjecting compounds of the formula 2

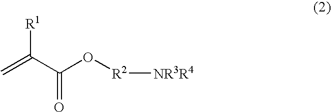

to polymerization, wherein the reaction temperature is initially at least 40° C. and is increased during the reaction at least once by at least 10° C.

R¹ is preferably a methyl group. R² is preferably an ethylene or propylene group, in particular an ethylene group. R³, R⁴ and R⁵ are preferably methyl or ethyl groups, in particular methyl groups. The molecular weight of the polymers according to the invention is preferably so great that they are solid at room temperature (20° C.). Particular preference is given to molecular weights (number-average) between 50 000 and 5 000 000, in particular 40 000 and 2 000 000 g/mol.

The last-mentioned method produces intermediates for the production of the quaternized polymers according to the invention.

The polymerization can be carried out as free-radical polymerization, anionic polymerization, group transfer polymerization or coordinative polymerization.

It has been possible to establish that the quaternized polymers according to the invention attach to hard surfaces in the form of a film.

The compounds of the formula 2 generally comprise stabilizers which suppress their spontaneous polymerization, for example 2,6-dimethyl-phenol. Such stabilizers also prevent free-radical polymerization reactions. The stabilizers can be removed in the method according to the invention by suitable measures, such as, for example, distillation. It is, however, also possible, and also preferred in industrial application, to leave the stabilizers in the compounds of the formula 2.

Suitable initiators for the method according to the invention are the initiators for free-radical polymerizations known in the prior art, preference being given to azoisobutyronitrile. The weight ratio of compounds of the formula 2 to the initiator is preferably below 600:1, in particular below 250:1.

The polymerization is preferably carried out at temperatures between 50 and 80° C., in particular 55 to 70° C. The increase in the reaction temperature by at least 10° C., which is carried out at least once, preferably takes place after 40% of the total reaction time, in particular after 50% of the total reaction time.

The polymerization can be carried out in a solvent. Examples of suitable solvents are lower alcohols and lower alkylbenzenes, preferably methanol or toluene. The polymerization can also be carried out in the absence of solvents.

If a solvent is used, then the concentrations of the monomers are preferably about 30 to 50% by weight.

The quaternization of the polymers produced by polymerization of compounds of the formula 2 preferably takes place in a solvent which dissolves the polymer but not the quaternization product. Examples of such solvents are the C₁- to C₆-alcohols, in particular isobutanol.

The quaternization is preferably carried out with dialkyl sulfates, in particular dimethyl sulfate.

The process according to the invention characterized by the at least single increase in the reaction temperature by 10° C. produces yields of polymer which are greater than 90%. It can therefore particularly advantageously be combined with the use of unpurified monomers since this reduces the expenditure, particularly in the case of industrial application.

The quaternized polymers according to the invention may be homo-polymers or copolymers. The formation of copolymers may, for example, result when the polymerization is carried out in a solvent which is able to exchange with the ester structural units of the monomers or polymers. Such solvents are, for example, alcohols, such as methanol.

The formation of copolymers can also result when a further comonomer is present during the polymerization. Suitable further comonomers are olefinically unsaturated compounds which are able to copolymerize with the compounds of the formula (2), and which generally carry 2 to 10 carbon atoms, and optionally oxygen and/or nitrogen atoms and/or 1 to 100 alkoxy groups.

Examples of such compounds are

olefins with 2 to 10 carbon atoms

(meth)acrylic acid, maleic acid, maleic anhydride, fumaric acid, itaconic acid

vinyl alkyl ethers with alkyl groups of 1 to 8 carbon atoms,

(meth)acrylamides with N-terminal alkyl(ene) groups of 1 to 4 carbon atoms

vinyl glycol ethers with 1 to 100 alkoxy groups, and

ethylene sulfonate.

The olefins are straight-chain or branched olefins, preferably with a terminal double bond, also preferably with 3 to 6 carbon atoms.

Preferred vinyl alkyl ethers carry alkyl groups of 1 to 12, in particular 2 to 6, carbon atoms.

A preferred (meth)acrylamide is acrylamidopropenylsulfonic acid (AMPS).

Vinyl glycol ethers conform to the formula 4

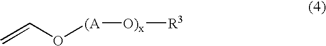

in which x is a number from 1 to 100, A is C₂- to C₄-alkylene and R³ is H or C₁- to C₆-alkyl. Preferably, A is an ethylene group, and R³ is hydrogen.

Further comonomers apart from those of the formula 2 may constitute up to 70 mol %, preferably up to 50 mol %, in the polymer.

### EXAMPLES

### Example 1

0.15 g of recrystallized azobisisobutyronitrile (AIBN), 17.98 g of freshly distilled dimethylaminoethyl methacrylate (DMAEMA) and 55 ml of distilled methanol were flushed with argon in a 100 ml flask for 30 minutes. The flask was then sealed and heated to 65° C. in the oil bath. The polymerization was carried out without stirring. After 3 h, the flask was cooled to 25° C., opened and left to stand for 1 day. After the methanol had been distilled off, 15.78 g of polymer were obtained. This product was dissolved in 60 ml of methanol and precipitated with 600 ml of hexane. This purification was repeated three times. The resulting product was dried at 60° C. under reduced pressure for 2 days. The yield was 11.52 g of polymer. The polymer comprised 42.5 mol % of DMAEMA and 57.5 mol % of methyl methacrylate (MMA).

### Example 2

0.155 g of AIBN, 11.06 g of unpurified DMAEMA and 55 ml of methanol were introduced into a 100 ml flask. The flask was filled with argon, sealed and heated to 65° C. (without stirring). After 3 h, the clear liquid was cooled to 25° C., opened and left to stand for 1 day. Methanol was then distilled off. The polymer obtained (15.78 g) was taken up three times in succession in 60 ml of methanol and precipitated with 600 ml of hexane. Drying was carried out for 2 days at 60° C. under reduced pressure. The yield was 5.124 g, the content of MMA was 62 mol %, that of DMAEMA was 38 mol %.

### Example 3

0.0304 g of AIBN, 3.11 g of unpurified DMAEMA and 4.85 g of toluene were introduced into a 20 ml flask. This was filled with argon, sealed and heated to 65° C. without stirring. After 16 h, the reaction mixture was cooled to 25° C. Toluene and excess monomer were stripped off under reduced pressure at 70° C. This gave 3.05 g of polymer, yield 98%.

### Example 4

0.151 g of AIBN and 9.35 g of unpurified DMAEMA were introduced into a 100 ml flask. This was filled with argon, sealed and heated to 65° C. without stirring. After 16 h, the soft foam obtained was cooled to 25° C. The residual monomer was stripped off at 70° C. under reduced pressure. This gave 9.15 g of polymer, corresponding to a yield of 97%.

### Example 5

0.289 g of AIBN, 20 g of freshly distilled DMAEMA and 20 g of toluene were introduced into a 100 ml flask. The flask was filled with argon, sealed and heated to 65° C. without stirring. After 1.5 and 5 hours, samples were taken in each case. These samples were cooled to −26° C. After 16 hours, the polymerization was ended by cooling the reaction flask.

### Examples 6 and 7

Examples 6 and 7 were carried out in accordance with the same method as example 5. In example 6, 0.0836 g of AIBN was used, and in example 7 0.0348 g of AIBN was used.

### Example 8

0.2089 g of AIBN, 20 g of DMAEMA, which was stirred for half an hour under reduced pressure, and 20 g of toluene were introduced into a 1.00 ml flask. The flask was filled with argon, sealed and heated to 65° C. without stirring. After 1.5 and 5 hours, samples were taken from the flask. These samples were cooled to −26° C. After 16 hours, the polymerization was ended by cooling the flask.

### Examples 9 and 10

Examples 9 and 10 were carried out in the same way as example 8. In example 9, 0.0836 g of AIBN was used, and in example 10 0.0348 g of AIBN was used.

### Example 11

0.107 g of AIBN and 10 g of DMAEMA, which were stirred beforehand for half an hour under reduced pressure, were introduced into a 100 ml flask.

The flask was filled with argon, sealed and heated to 65° C. After various times samples of the reaction mixture were taken and cooled to −26° C. The polymerization was ended after 30 hours by cooling the flask.

### Example 12

Example 12 was carried out in the same way as example 11 but the reaction temperature was 75° C.

### Example 13

Example 13 was carried out in the same way as example 11 but the reaction temperature was 55° C.

### Examples 14 to 18

The quaternization of the polymers, the preparation of which has already been described in examples 1 to 13, was carried out by reacting 10% strength by weight polymer solutions in isobutanol with dimethyl sulfate. For this purpose, solutions of in each case 3 g of polymer in 27 g of isobutanol were prepared. These solutions were introduced into a round bottomed flask which was equipped with thermometer, stirrer and dropping funnel. Different amounts of dimethyl sulfate were initially placed in the dropping funnel. The reaction mixture was cooled with an isopropanol/dry ice mixture. The dropping rate of the dimethyl sulfate was adjusted such that the reaction mixture could be kept at about 25° C. The addition of dimethyl sulfate was initially ended when the reaction mixture became so viscous that further stirring was no longer possible. Prior to adding the remaining amount of dimethyl sulfate, the viscous reaction mixture was stirred beforehand with a spatula. The stirring with a spatula was continued after the addition of dimethyl sulfate was complete for a further 15 minutes at a temperature of 25° C. The product obtained in this way was left to stand at room temperature for a period from 10 to 15 hours, washed with diethyl ether and then dried in a vacuum desiccater over activated carbon. Residual solvent was stripped off under reduced pressure at elevated temperature. The table below gives the exact conditions and results of the quaternization of polymers according to examples 14 to 18.

TABLE 1
Examples 14 to 18 for the quaternization of polymers

| | | | | | | Yieid of | |
|---|---|---|---|---|---|---|---|
| | | | Dimethyl | | | quaternized | |
| | | | sulfate | | DMS/ | polymer | |
| Ex- | Polymer | | (DMS) | | PDMAEMA | Amount | Yield |
| ample | [g] | [mmol] | [g] | [mmol] | [mol/mol] | [g] | [%] |
| 14 | 3.00 | 19.1 | 2.62 | 20.8 | 1.09 | 4.960 | 91.7 |
| 15 | 3.00 | 19.1 | 2.10 | 16.6 | 0.87 | 4.578 | 93.0 |
| 16 | 3.00 | 19.1 | 1.58 | 12.5 | 0.65 | 3.880 | 87.3 |
| 17 | 3.00 | 19.1 | 1.05 | 8.3 | 0.43 | 3.223 | 81.5 |
| 18 | 3.00 | 19.1 | 0.52 | 4.2 | 0.22 | 2.628 | 75.5 |

### Example 19

49.94 g of DMAEMA were evacuated in a water-jet vacuum to withdraw oxygen for half an hour at 30° C. After the evacuation, the weight of the DMAEMA was 49.86 g. In a reaction vessel, the DMAEMA was mixed with 0.386 g of AIBN, the reaction vessel was filled with argon and sealed. The reaction vessel contained a thermometer and a steel pipe through which argon could be admitted during the polymerization reaction. The reaction mixture was not stirred during the polymerization. After 60 minutes, the temperature of the reaction mixture was 72.6° C. The reaction mixture was then cooled in a water bath to a temperature of 20° C. After the reaction mixture had been dipped into the water bath, the temperature of the reaction mixture increased to 940 within 5 minutes and remained at 94° C. for a further 7 minutes. After a further 15 minutes, the temperature had dropped to 53° C. The reaction vessel was then placed into a heated water bath at 55° C. After a further 50 minutes, the temperature of the reaction mixture was 64.9° C. After a further 3½ hours, the reaction mixture had assumed the temperature of the water bath of 55° C.

### Example 20

50.18 g of DMAEMA were evacuated for half an hour at room temperature under water-jet vacuum. The weight of the monomer purged of oxygen in this way was 50.14 g. These 50.14 g of DMAEMA were mixed in a reaction vessel with 0.5086 g of AIBN, and the reaction vessel was filled with argon and sealed. During the polymerization reaction which subsequently started, a maximum difference in the temperatures between the water bath and the reaction mixture arose after a reaction time of 5 hours. 8 hours after the onset of the reaction, the temperatures of the reaction mixture and of the water bath had largely equalized. The maximum temperature difference between reaction mixture and water bath was 10.6° C.

### Example 21

50.4 g of DMAEMA were evacuated for half an hour at room temperature under water-jet vacuum. From this were obtained 49.98 g of oxygen-purged DMAEMA. This was mixed in the reaction vessel with 0.148 g of AIBN, and the reaction vessel was filled with argon and sealed. During the polymerization reaction which then started, a maximum difference in the temperatures of the reaction mixture to the temperature of the water bath was 11.25° C. after 200 minutes. After a reaction time of a total of 5 hours, the temperatures of the water bath and of the reaction mixture had equalized. They were then both 55° C.

### Example 22

150.3 g of DMAEMA were placed under a vacuum for half an hour at room temperature using a water-jet pump. The weight of the monomer freed from oxygen obtained thereby was 150.1 g. The monomer was then placed in a reaction vessel with 0.3756 g of AIBN. The reaction vessel was filled with argon and sealed. The reaction vessel was equipped with a stirrer. The temperature of the reaction mixture increased within 110 minutes from 55 to 100.5° C. The reaction was then ended by immersion into a water bath at 20° C.

### Example 23

150.2 g of DMAEMA were evacuated for half an hour at room temperature using a vacuum pump. From this were obtained 150.0 g of oxygen-purged DMAEMA. These were mixed in a reaction vessel with 0.784 g of AIBN.

The reaction vessel had a stirrer. It was sealed and placed in a silicone oil bath. Within the next 5 hours, the temperature rose from 45 to 53° C., and about 6 hours after the onset of the reaction, the viscous reaction mixture could no longer be stirred. After a total of 6½ hours, the temperature of the reaction mixture was 132° C. The temperature of the silicone bath was then raised to 109° C., during which the temperature of the reaction mixture dropped to 100° C. The tables below show reaction conditions and results of examples 19 to 23.

TABLE 2
Reaction conditions of the bulk polymerization of DMAEMA

| | Bath | Amount of | DMAEMA/AIBN | |
|---|---|---|---|---|
| | temperature | monomer | ratio | |
| Example | (° C.) | (g) | (mol/mol) | Stirrer |
| 19 | 55 | 50 | 100 | no |
| 20 | 45 | 50 | 100 | no |
| 21 | 55 | 50 | 400 | no |
| 22 | 55 | 150 | 400 | yes |
| 23 | 45 | 150 | 200 | yes |

TABLE 3
Results of the bulk polymerization of DMAEMA

| | | Maximum | | |
|---|---|---|---|---|
| | Maximum | temperature | | Molecular |
| | temperature | difference | | weight |
| | increase per | between reaction | Conversion | (GPC) in kD |
| Example | minute | mixture and bath | % | (Mw/Mn) |
| 19 | 13 | 39.5 | 61.4 | |
| 20 | 0.24 | 10.65 | 88.1 | |
| 21 | 0.10 | 11.25 | 94.4 | |
| 22 | 3.5 | 55.8 | 56.8 | 538 (8.96) |
| 23 | 9.4 | 87 | | 1300 (6.50) |

### Example 24

2.7 g of AIBN were dissolved in 712 ml of DMAEMA. The solution was stirred under reduced pressure for half an hour and flushed with argon at room temperature. 1 l of distilled toluene was then added. The stirred solution was heated to 60° C., as a result of which the polymerization reaction was started. Over the course of 6 hours, the temperature was increased to 70° C., and after a total reaction time of 12 hours, the reaction mixture was cooled. After the reaction mixture had cooled, 1 l of hexane was added and the product was precipitated with a further 6 l of hexane. The white precipitate was dissolved in 2 l of acetone, filtered and dried educed pressure.

### Example 25

5% by weight of the polymer according to the invention from example 14 were incorporated into a cleaning formulation for fine stone floors. The cleaning formulation also comprised bactericides, nonionic surfactants and water, and had a pH of 10.

The cleaning formulation was used in a 1:100 dilution for the manual cleaning of a fine stone floor. It was observed that the floor cleaned in this way has a better soil-repelling property than a floor which was machine-treated with a comparable formulation which does not comprise the polymer according to the invention.

### Example 26

1% by weight of the polymer according to the invention from example 14 was incorporated into a spray cleaner formulation for stainless steel surfaces. The cleaning formulation also comprised bactericides, nonionic surfactants and water, and had a pH of 4.3.

The cleaning formulation was used neat for the manual cleaning of a stainless steel surface. It was observed that the surface cleaned in this way has a better soil-repellant property than a surface which has been treated with a comparable formulation which does not comprise the polymer according to the invention.

### Example 27

Alkaline cleaning formulations (according to example 25) and acidic cleaning formulations (according to example 26) were prepared in which the concentration of the polymers according to example 14 were in each case 0.1, 0.5 and 1.0% by weight. These cleaning formulations were in each case applied to a plastic sheet, a stainless steel sheet and a fine stone tile.

To demonstrate that the polymers according to the invention attach to the surfaces, secondary ions—time of flight mass spectra were recorded from the surfaces (TOF—SIMS).

Polydimethylaminoethyl methacrylate methosulfate could clearly be detected on each cleaned surface (plastic sheet, stainless steel sheet, fine stone tile) in all three applied concentrations (0.1%, 0.5% and 1%).

Within a surface material, no dependency of the intensities of the characteristic signal lines of the polydimethylaminoethyl methacrylate methosulfate compound on the active ingredient concentration used in the cleaning composition was found.

The highest signal intensities were observed in the spectra of the fine stone tiles. The intensities measured on the plastic sheets and metal sheets were approximately the same. This is true equally for the alkaline and for the acidic cleaners.

1. A method of attaching soil release polymers to hard surfaces comprising the steps of:
providing soil release polymers consisting essentially of structural units of the formula 1 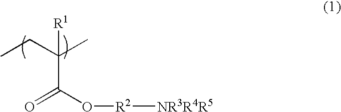
in which
R¹ is hydrogen or methyl,
R² is C₁- to C₄-alkylene,
R³, R⁴ and R⁵, independently of one another, are C₁- to C₄-alkyl groups;
providing a hard surface; and
attaching said soil release polymers to said hard surface.

2. The method of attaching soil release Polymers to hard surfaces according to claim 1, in which R¹ is a methyl group.

3. The method of attaching soil release polymers to hard surfaces according to claim 1, in which R² is an ethylene or propylene group.

4. The method of adding soil release polymers to hard surfaces according to claim 1, where R³, R⁴ and R⁵ are methyl or ethyl groups.

5. The method of adding soil release polymers to hard surfaces according to claim 1, in which the molecular weight of the polymers is between 50 000 and 5 000 000 g/mol.

6. A method for the production of polymers consisting essentially of structural units of the formula 1 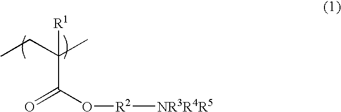
in which
R¹ is hydrogen or methyl,
R² is C₁- to C₄-alkylene,
R³, R⁴ and R⁵, independently of one another, are C₁- to C₄-alkyl groups,
comprising the steps of:
providing compounds of the formula 2 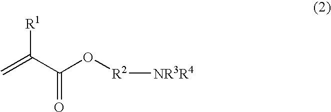
polymerizing said compounds of the formula 2 to obtain a resulting product; and
reacting the resulting product with a suitable alkylating agent, which inserts the radical R⁵ such that the polymers of the formula 1 arise, wherein the reaction temperature is initially at at least 40° C. and is increased during the reaction at least once by at least 10° C.

7. A method for the production of polymers consisting essentially of structural units of the formula 3 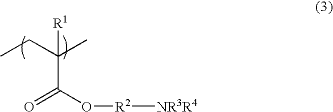
in which
R¹ is hydrogen or methyl,
R² is C₁- to C₄-alkylene,
R³, R⁴, independently of one another, are C₁- to C₄-alkyl groups,
comprising the steps of:
providing compounds of the formula 2 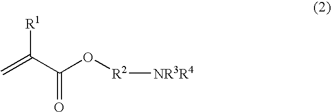
polyimerizing said compounds of the formula 2, wherein the reaction temperature is initially at least 40° C. and is increased during the reaction at least once by at least 10° C.
